(19) United States
(12) Patent Application Publication
(10) Pub. No.: US 2021/0072421 A1
(43) Pub. Date: Mar. 11, 2021

(54) METHODS AND MEANS FOR NEUTRON IMAGING WITHIN A BOREHOLE

(71) Applicant: Philip Teague, Spring, TX (US)

(72) Inventor: Philip Teague, Spring, TX (US)

(21) Appl. No.: 17/099,429

(22) Filed: Nov. 16, 2020

Related U.S. Application Data
(63) Continuation of application No. 16/276,170, filed on Feb. 14, 2019, now abandoned.
(60) Provisional application No. 62/630,375, filed on Feb. 14, 2018.

(51) Int. Cl. G01V 5/10; G01V 5/14

(52) U.S. Cl. CPC G01V 5/10; G01V 5/14

(57) ABSTRACT

A borehole neutron imaging tool having a two-dimensional array of neutron detector crystals, wherein said tool includes at least a source of neutrons; at least one collimated imaging detector to record images created by incident neutrons; sonde-dependent electronics; and a plurality of tool logic electronics and power supply units. A method for borehole neutron imaging, the method including controlling the direction of incident neutrons onto the imaging array; imaging said borehole surroundings; and creating a composite image of the materials surrounding the formation.

### TECHNICAL FIELD

The present invention relates generally to directional neutron porosity imaging of formation and cement volumes surrounding a borehole, and in a specific though non-limiting embodiment to methods and means for enabling a wireline operator to evaluate the homogeneity of cement disposed behind a casing using azimuthal neutron porosity imaging.

### BACKGROUND

Neutron tools have been used for several decades to measure the neutron porosity and hydrogen index of earth formations. Modern tools typically use pulsed neutron sources and thermal and/or epithermal neutron detectors for the measurement of the neutron flux of the neutrons at several distances from the neutron source. Additionally, the neutron “retardation time,” as measured by one or more of the detectors, is a shallow measurement of hydrogen index and very sensitive to standoff. The traditional porosity measurement relies on deriving liquid filled porosity from the ratio of the neutron fluxes from at least two different distances from the source.

Unfortunately, such neutron logging tools are unable to offer azimuthal logging information. Instead, the two or more detector assemblies are spaced apart longitudinally along the body of the neutron logging tool a short distance from the neutron source, and the detector assemblies are in line with each other along a central axis of the tool.

Consequently, the detector assemblies make their detections of the adjacent wall of the borehole without regard to direction or orientation. Instead, the multiple detector assemblies only provide other, different types of formation and statistical sensitivities during logging operations.

The detectors closest to the neutron generator (“near space”) are typically more sensitive and responsive to the borehole, and the detector assemblies further from the neutron generator (“far space”) are typically more sensitive and responsive to the formation. The sigma capture cross-section of the borehole and borehole's surroundings may then be determined by applying different weights to the near space readings as compared to the far space readings.

For example, in a tool with two detectors, 70% weight may be given for the near detector reading and 30% weight for the far detector reading. A typical open-hole neutron logging tool is usually run decentralized to the wellbore with an offset spring such that the neutron logging tool effectively runs along one wall of the wellbore.

Other current logging tools have multiple detectors spaced about the circumference of the tool. The detectors are often shielded from one another such that each detector detects from the area of the borehole and formation to which it is closest. The readings from each detector are then associated with the orientation of that detector in order to provide information regarding the incident direction of the incoming particles or photons. The orientation-specific data is then analyzed to provide a basic azimuthal log.

Nowhere in the prior is it taught that a neutron detector may be segmented and collimated upon a plane to create a two-dimensional imaging device that can accurately recreate the distribution neutrons incident to a two-dimensional plane.

US 20180239053 to Teague teaches a neutron porosity tool having an electronic neutron generator arrangement and a control mechanism used to provide voltage and pulses to an electronic neutron tube, the neutron generator arrangement including at least one vacuum tube; at least one ion target; at least one radio-frequency cavity; at least one high-voltage generator; at least two neutron detectors; at least one pulser circuit; and at least one control circuit.

US 20180120474 to Teague teaches an azimuthal neutron porosity tool for imaging formation and cement volumes surrounding a borehole, the tool including at least an internal length comprising a sonde section, wherein said sonde section further comprises one sonde-dependent electronics; a slip-ring and motor section; and a plurality of tool logic electronics and PSUs.

U.S. Pat. No. 8,664,587 to Evans et al. discloses a method and means for creating azimuthal neutron porosity images in a ‘logging while drilling’ environment. As bottom hole assembly based systems historically relied upon the rotation of the drill string to assist in the acquisition of azimuthally dependent data, the patent discusses an arrangement of azimuthally static detectors that could be implemented in a modern BHA, which does not necessarily rotate with the bit, by subdividing the neutron detectors into a plurality of azimuthally arranged detectors shielded within a moderator so as to infer directionality to incident neutrons and gamma rays.

U.S. Pat. No. 9,012,836 to Wilson et al. discloses a method and means for creating azimuthal neutron porosity images in a wireline environment. Similar to U.S. Pat. No. 8,664,587, the patent discusses an arrangement of azimuthally static detectors which could be implemented in a wireline tool in order to assist an operator in interpreting logs post-fracking by subdividing the neutron detectors into a plurality of azimuthally arranged detectors shielded within a moderator so as to infer directionality to incident neutrons and gamma rays.

U.S. Pat. No. 5,374,823 to Odom discloses a well logging tool that depends upon neutron bursts for determining inelastic energy spectra and thermal neutron capture cross-sections during a single logging pass over a well depth interval.

20110238313 to Thornton et al. discloses a method for correction of borehole effects in a neutron porosity measurement. Two or more neutron detectors are used to determine the azimuthal component that could be attributed to the non-padded side of the tool such that a caliper may not be required.

U.S. Pat. No. 5,278,758 to Perry et al. discloses a method and apparatus for nuclear porosity logging. In accord with the disclosure a pair of spaced lithium detectors, preferably comprising Li6 crystal or Li6 doped glass, are used to detect neutrons emitted from a borehole formation being logged. In addition, novel data processing is used to strip the gamma-ray peak from the spectrum developed by the lithium detectors.

20120312994 to Nikitin et al. discloses a single pixel scintillation detector that includes a photodetector; a scintillating material (possibly Li6 glass) configured to emit light in response to exposure to ionization particles; an optically transparent material having a light absorption coefficient that is less than a light absorption coefficient of the scintillating material, the optically transparent material optically coupled to a surface of the scintillating material and configured to transmit the emitted light; and a reflective material at least partially surrounding the scintillating material and the optically transparent material, the reflective material configured to reflect the emitted light and direct the emitted light toward the photodetector.

U.S. Pat. No. 4,419,578 to Kress discloses a solid-state neutron detector for detecting both fast and slow neutrons comprises two layers, one of which contains a neutron-sensitive first material and the other of which contains a semiconducting second material containing hydrogen, the first and second materials meeting to form a rectifying junction therebetween. The neutrons are detected by detecting electron-hole pairs migrating in opposite directions relative to the junction. The electron-hole pairs are created by energetic free protons produced by the fast neutrons travelling through the second material and by energetic reaction particles produced by the slow neutrons travelling through the first material. Stacking several of these detectors next to each other enhances overall sensitivity for detecting both fast and slow neutrons.

U.S. Pat. No. 5,410,156 to Miller discloses an improved fast neutron x-y detector and radiographic/tomographic device utilizing a white neutron probe. The invention teaches of the detection of fast neutrons over a two-dimensional plane, measures the energy of the neutrons, and discriminates against gamma rays. In a preferred embodiment, the detector face is constructed by stacking separate bundles of scintillating fiber optic strands one on top of the other. The first x-y coordinate is determined by which bundle the neutron strikes. The other x-y coordinate is calculated by measuring the difference in time of flight for the scintillation photon to travel to the opposite ends of the fiber optic strand. In another embodiment, the detector is constructed of discrete scintillator sections connected to fiber optic strands by couplers functioning as lens. The fiber optic strands are connected to a multi-anode photomultiplier tube.

U.S. Pat. No. 5,880,469 to Miller discloses an apparatus and method for discriminating against neutrons coming from directions other than a preferred direction and discriminating against gamma rays. Two photomultiplier tubes are parallel to each other and are attached to one end of a light pipe. A neutron scintillator is attached to the other end of the light pipe. The scintillator is comprised of optical fibers arranged contiguously along a first direction, which is perpendicular to a length dimension of the optical fibers, and which optical fibers alternate between optical fibers which emit photons only in the lower portion of the electromagnetic spectrum and optical fibers which emit photons only in the higher portion of the electromagnetic spectrum.

U.S. Pat. No. 3,566,118 to Peters discloses a ‘single pixel’ neutron and gamma ray detector including in combination one detector that detects gamma rays and another detector that detects neutrons in the presence of a large flux of gamma rays. The two detectors are combined in such a manner that the scintillator material of the gamma detector becomes the moderator material of the neutron detector.

U.S. Pat. No. 3,483,376 to Locke discloses a well logging tool comprising a source of neutrons for establishing a neutron population in the vicinity of the tool, a first neutron detector spaced from said source, a second neutron detector relatively more sensitive to the neutron population thereabout than said first detector and spaced from said neutron source a distance at least equal to the distance between the source and the opposite end of said first neutron detector, means for computing the ratio of neutrons detected by said first and second detectors.

U.S. Pat. No. 3,567,936 to Tittman discloses an earth formation porosity logging tool that comprises a neutron source and four neutron detectors spaced at different distances from the source for transport through a borehole. Signals are obtained that correspond to the ratios of the counts registered by the two short-spaced detectors and the two long-spaced detectors. The effect of the borehole characteristics on the formation porosity measurement is compensated by directly contrasting these ratio signals with each other.

U.S. Pat. No. 6,362,485 to Joyce discloses a neutron monitoring instrument, principally of the survey type, is provided with an inner neutron detector(s) enclosed in a layer of neutron attenuating material and one or more outer neutron detectors provided on the attenuating layer and enclosed in a layer of neutron moderating material. The inner detector(s) monitor neutrons in the 100 KeV to 15 MeV energy range, with the outer detectors monitoring neutrons in the thermal to 100 KeV range. Sensitivity across the spectrum and evenness of response are improved compared with the prior art to give better close equivalence determinations.

U.S. Pat. No. 8,421,004 to Molz et al. discloses a method of building detectors within a moderating material or shield for either neutrons or gamma rays.

### SUMMARY

A borehole neutron imaging tool having a two-dimensional array of neutron detector crystals is provided, the tool including at least a source of neutrons; at least one collimated imaging detector to record images created by incident neutrons; sonde-dependent electronics; and a plurality of tool logic electronics and power supply units.

A method for borehole neutron imaging, the method including controlling the direction of incident neutrons onto the imaging array; imaging said borehole surroundings; and creating a composite image of the materials surrounding the formation.

### BRIEF DESCRIPTION OF THE DRAWINGS

FIG. 1 illustrates a neutron imaging tool being lowered into a well by means of wireline conveyance, in addition to the fractures surrounding the cased wellbore.

FIG. 2 illustrates one example of an arrangement of an arrayed neutron imaging detector using an arrangement of square pixels.

FIG. 3 illustrates one example of an arrangement of an arrayed neutron imaging detector using an arrangement of round pixels.

FIG. 4 illustrates one example of an arrangement of an arrayed neutron imaging detector wherein the individual pixels are arrayed to form a hemispherical dragon-fly eye format.

FIG. 5 illustrates one example of an arrangement of an arrayed neutron imaging detector using an arrangement of square pixels.

### BRIEF DESCRIPTION OF SEVERAL EXAMPLE EMBODIMENTS

The invention described herein comprises both methods and means for enabling a wireline operator to evaluate the homogeneity of cement behind casing through azimuthal neutron porosity imaging in pursuit of determining cement integrity and zonal isolation. The method and means also permits for the evaluation of cement behind casing when the wireline tool is located within tubing inside of casing which is cemented. This is especially useful when considering plug and abandonment operations where it would be highly advantageous to be able to determine to quality of the zonal isolation and integrity of the cement being the casing prior to removal of the tubing. The method and means also permits for azimuthal information to be attained during logging of open-hole environments which would be of particular value when determining fracture efficiencies and fracture biases in the formation after fracking operations have been performed. This disclosure does not limit the possibility of combining the package with other forms of cement characterization, such as acoustic or x-ray, nor combinability of the means with other types of well logging methods.

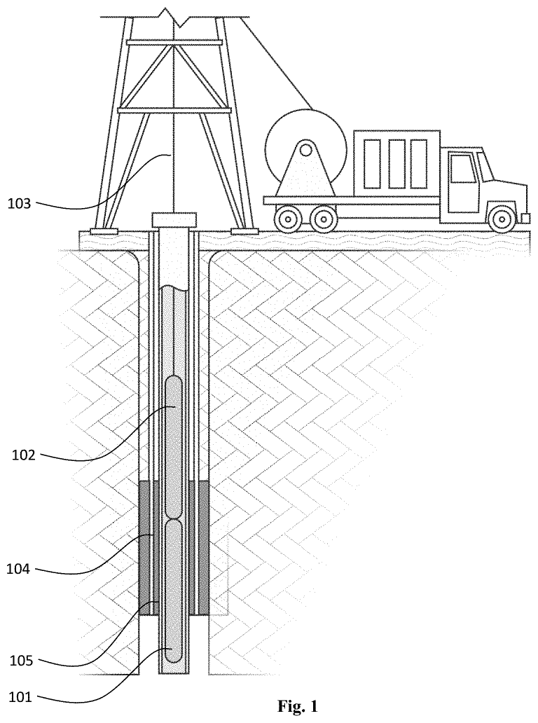

In one embodiment (and with reference now to FIG. 1), a neutron porosity imaging logging tool [101] is accompanied by an x-ray cement evaluation and/or acoustic imaging tool [102] by wireline conveyance [103] into a cased borehole, wherein the cemented section of the well [104] is logged through the inner-most casing or tubing [105].

The tool [101] houses a neutron source that emits neutrons into the materials surrounding the wellbore. A detector array [206], or a plurality of detector arrays, or an azimuthally distributed plurality of detector arrays are set do look radially outward into the materials surrounding the wellbore.

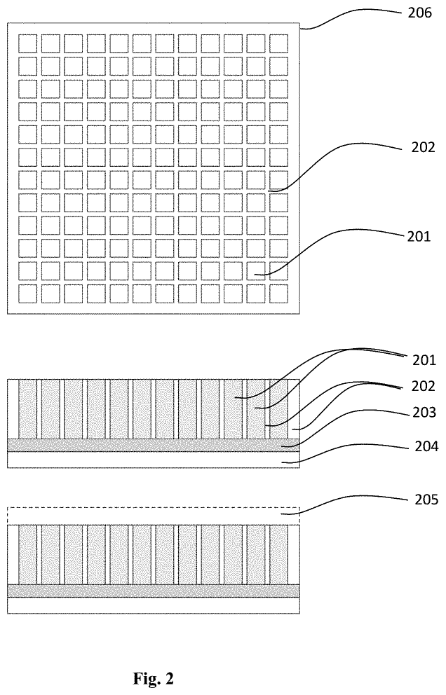

FIG. 2 illustrates how an array of individual square-formed (Lithium-6) Li6-doped glass or Li6I crystals [201] are located within a matrix of material [202] with a very high neutron capture cross-section, such as Boron-10 or Cadmium, to form collimation for the incident neutron directionality. The matrix is optically coupled to a scintillator [203] such as Cadmium Telluride, Cadmium Zinc Telluride, Sodium Iodide, Cesium Iodide or Lanthanum Bromide, which is additionally bonded to a CMOS or CCD array [204].

In a further embodiment, an additional Gadolinium [205] ‘layer’ can be used around the collimated shield matrix to convert epithermal neutrons into thermal neutrons.

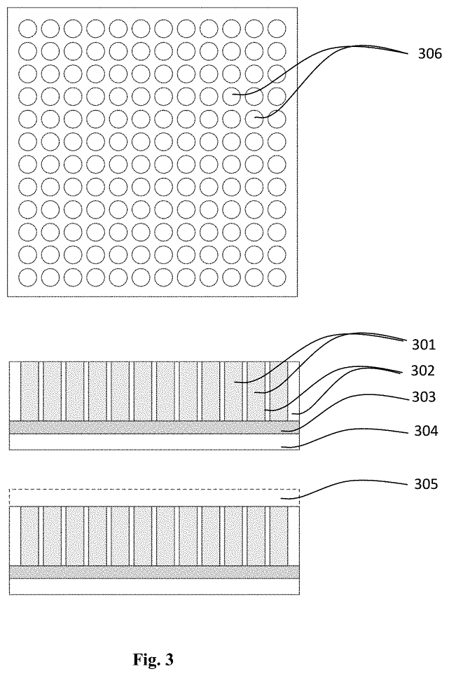

FIG. 3 illustrates how an array of individual cylindrically-formed [306] (Lithium-6) Li6-doped glass or Li6I crystals [301] are located within a matrix of material [302] with a very high neutron capture cross-section, such as Boron-10 or Cadmium, to form collimation for the incident neutron directionality. The matrix is optically coupled to a scintillator [303] such as Cadmium Telluride, Cadmium Zinc Telluride, Sodium Iodide, Cesium Iodide or Lanthanum Bromide, which is additional bonded to a CMOS or CCD array [304].

In a further embodiment, an additional Gadolinium [305] ‘layer’ can be used around the collimated shield matrix to convert epithermal neutrons into thermal neutrons.

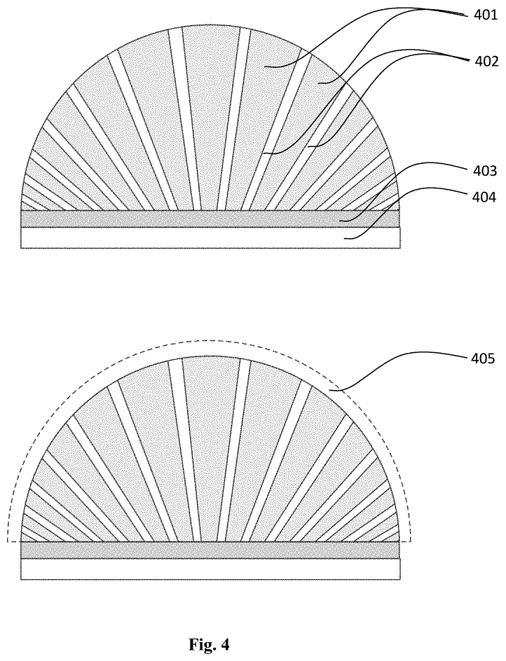

FIG. 4 illustrates how an array of individual Li6-doped glass or Li6I crystals [401] are distributed in an azimuthally aligned arrangement and located within a matrix of material [402] with a very high neutron capture cross-section, such as Boron-10 or Cadmium, to form collimation for the neutron directionality. The matrix is optically coupled to a scintillator [403] such as Cadmium Telluride, Cadmium Zinc Telluride, Sodium Iodide, Cesium Iodide or Lanthanum Bromide, which is additional bonded to a CMOS or CCD array [404].

In a further embodiment, an additional Gadolinium [405] ‘layer’ can be used around the collimated shield matrix to convert epithermal neutrons into thermal neutrons.

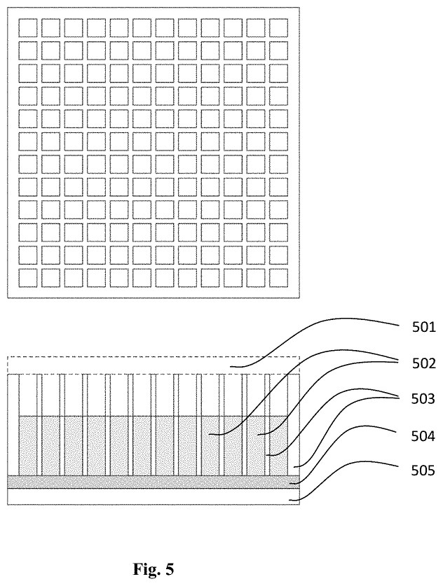

FIG. 5 illustrates how an array of individually-formed [502] (Lithium-6) Li6-doped glass or Li6I crystals are located within a matrix of material [503] with a very high neutron capture cross-section, such as Boron-10 or Cadmium, to form collimation for the incident neutron directionality. The matrix is optically coupled to a scintillator [504] such as Cadmium Telluride, Cadmium Zinc Telluride, Sodium Iodide, Cesium Iodide or Lanthanum Bromide, which is additional bonded to a CMOS or CCD array [505]. The shielding material [503] may be extended beyond the surface of the Li6 arrays [502] such that the collimator ratio is increased, and the solid-angle of neutron detection decreased—thereby increasing the positional resolution of the origin of the incoming neutron.

In a further embodiment, an additional Gadolinium [501] ‘layer’ can be used around the collimated shield matrix to convert epithermal neutrons into thermal neutrons.

In a further embodiment, six detector arrays are assembled into a cube shape, such that the detector assemble can be used to determine the general direction (in 3D space) from which the neutron arrived.

In an alternative embodiment, the square-formed Li6-doped glass or Li6I crystals could be replaced with cylindrical Li6-doped glass or Li6I crystals.

In a further embodiment, an array of individual Li6-doped glass or Li6I crystals are distributed in an azimuthal arrangement and located within a matrix of material with a very high neutron capture cross-section, such as Boron-10 or Cadmium, to form collimation for the neutron directionality. The matrix is optically coupled to a scintillator such as Cadmium Telluride, Cadmium Zinc Telluride, Sodium Iodide, Cesium Iodide or Lanthanum Bromide, which is additional bonded to a CMOS or CCD array. An additional Gadolinium ‘wrap’ can be used around the collimated shield matrix to convert epithermal neutrons into thermal neutrons.

In a further embodiment, the detectors can be manipulated by actuators such that the operator can adjust the directionality of the array. In an alternative form of the embodiment, an array or plurality of arrays can be rotated around the central axis of the tool, such that a spiral imaging log or cylindrical imaging log of the wellbore surroundings can be created.

In a further embodiment, the tool can be placed within a LWD string to produce azimuthal images of the formation in real-time, such that the directional-drilling head can be directed toward higher-porosity regions.

In a further embodiment, the output signal from either a proportion or all of the pixels may be combined for the purposes of improving or modifying the statistical analysis of the measured neutrons.

In a further embodiment, the output signal from either a proportion or all of the pixels may be displayed as a physical two-dimensional image of neutron intensity at the detector.

In a further embodiment, the shielding material may be removed such that the crystal array is contiguous.

In a further embodiment, the output of the imaging array is used to determine the porosity of materials surrounding the borehole.

In a further embodiment, the output of the imaging array is processing using machine learning, such that the energy and distribution of the detected neutrons may be used to determine the distribution and type of materials surrounding the borehole.

In a further embodiment, the neutron imaging tool, can be combined with x-ray, and/or acoustic tools.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A borehole neutron imaging tool having a two-dimensional array of neutron detector crystals, wherein said tool comprises:
a source of neutrons;
at least one collimated imaging detector to record images created by incident neutrons;
sonde-dependent electronics; and
a plurality of tool logic electronics and power supply units.

2. The tool of claim 1, wherein said collimated imaging detector further comprises a two-dimensional per-pixel collimated imaging detector array wherein the imaging array is multiple pixels wide and multiple pixels long.

3. The tool of claim 1, wherein said collimated imaging detector further comprises a plurality of two-dimensional per-pixel collimated imaging detector arrays wherein the imaging arrays are multiple pixels wide and multiple pixels long.

4. The tool of claim 1, wherein said collimated imaging detector further comprises a two-dimensional per-pixel collimated imaging detector array wherein the imaging array is multiple pixels wide and a single pixel long.

5. The tool of claim 1, wherein said collimated imaging detector collects energy information about the detected photons.

6. The tool of claim 1, wherein said collimated image neutron information is processed to analyze the content to determine the porosity of materials surrounding the borehole.

7. The tool of claim 1, wherein said collimated image neutron information is processed by use of machine learning to analyze the content to determine the material composition of materials surrounding the borehole.

8. The tool of claim 1, wherein said tool is configured so as to permit through-wiring.

9. The tool of claim 1, wherein said tool is combined with one or more other measurement tools comprising one or more of acoustic, ultrasonic, electromagnetic and/or other x-ray-based tools.

10. A method for borehole neutron imaging, wherein said method comprises:
controlling the direction of incident neutrons onto the imaging array;
imaging said borehole surroundings; and
creating a composite image of the materials surrounding the formation.

11. The method of claim 10, further comprising processing said collimated image energy information in order to analyze the spectral content to determine the material porosity.

12. The method of claim 10, further comprising processing said collimated image energy information by use of machine learning to analyze the spectral content to determine the material composition.

13. The method of claim 10, wherein said method is combined with one or more other measurement tools comprising one or more of acoustic, ultrasonic, electromagnetic and/or other x-ray-based tools.
